(19) United States
(12) Patent Application Publication
(10) Pub. No.: US 2026/0189287 A1
(43) Pub. Date: Jul. 2, 2026

(54) BEAM MANAGEMENT IN ACCORDANCE WITH A LOW-POWER MODE

(71) Applicant: QUALCOMM Incorporated, San Diego, CA (US)

(72) Inventors: Jung Ho RYU, Englewood Cliffs, NJ (US); Igor GUTMAN, Hod HaSharon (IL); Jelena DAMNJANOVIC, Del Mar, CA (US); Tao LUO, San Diego, CA (US); Junyi LI, Greentown, PA (US)

(21) Appl. No.: 19/001,916

(22) Filed: Dec. 26, 2024

(51) Int. Cl. H04B 7/06; H04W 52/02; H04W 56/00; H04W 76/20

(52) U.S. Cl. CPC H04B 7/06952; H04W 52/0229; H04W 56/0015; H04W 76/20

(57) ABSTRACT

Various aspects of the present disclosure generally relate to wireless communication. In some aspects, a user equipment (UE) may receive, from a network node while monitoring for a wakeup signal from the network node, a set of synchronization signal blocks (SSBs) that are respectively mapped to a set of SSB transmission resources. The UE may transmit, to the network node, a sequence via a resource associated with the set of SSB transmission resources, where the resource may be mapped to an SSB of the set of SSBs associated with a highest signal quality metric associated with the set of SSBs. The UE may receive, from the network node, a feedback communication that indicates successful reception of the sequence and an indication that one or more subsequent downlink transmissions are associated with a transmission configuration indication state associated with the SSB. Numerous other aspects are described.

### FIELD OF THE DISCLOSURE

Aspects of the present disclosure generally relate to wireless communication and specifically relate to techniques, apparatuses, and methods associated with beam management in accordance with a low-power mode.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some examples, one or more wireless devices may perform beam management and/or beam selection techniques in accordance with facilitating wireless communications. For example, a network node may transmit, and a user equipment (UE) may receive, a set of synchronization signal blocks (SSBs) across multiple beams, with each beam covering a specific spatial direction (e.g., each beam is associated with one or more spatial parameters such as a transmission configuration indicator (TCI) state and/or a quasi co-location (QCL) parameter, among other examples). The UE may monitor and measure the signal quality of the received SSBs, using metrics such as reference signal received power (RSRP) or signal-to-interference-plus-noise ratio (SINR). After evaluating the measurements, the UE may select the beam associated with the SSB that exhibits the highest signal quality of the set of SSBs. This selected beam may serve as a link for communication between the network node and the UE.

### SUMMARY

Some aspects described herein relate to a user equipment (UE) for wireless communication. The UE may include one or more memories and one or more processors coupled to the one or more memories. The one or more processors may be individually or collectively configured to receive, from a network node while monitoring for a wakeup signal (WUS) from the network node, a set of synchronization signal blocks (SSBs) that are respectively mapped to a set of SSB transmission resources. The one or more processors may be individually or collectively configured to transmit, to the network node, a sequence via a resource associated with the set of SSB transmission resources, wherein the resource is mapped to an SSB of the set of SSBs associated with a highest signal quality metric associated with the set of SSBs. The one or more processors may be individually or collectively configured to receive, from the network node, a feedback communication that indicates successful reception of the sequence and indicates that one or more subsequent downlink transmissions are associated with a transmission configuration indication (TCI) state associated with the SSB.

Some aspects described herein relate to a network node for wireless communication. The network node may include one or more memories and one or more processors coupled to the one or more memories. The one or more processors

may be individually or collectively configured to transmit, to a UE, a set of SSBs that are respectively mapped to a set of SSB transmission resources. The one or more processors may be individually or collectively configured to receive, from the UE, a sequence via a resource associated with the set of SSB transmission resources, wherein the resource is mapped to an SSB of the set of SSBs associated with a highest signal quality metric associated with the set of SSBs. The one or more processors may be individually or collectively configured to transmit, to the UE, a feedback communication that indicates successful reception of the sequence and indicates that one or more subsequent downlink transmissions are associated with a TCI state associated with the SSB.

Some aspects described herein relate to a method of wireless communication performed by a UE. The method may include receiving, from a network node while monitoring for a WUS from the network node, a set of SSBs that are respectively mapped to a set of SSB transmission resources. The method may include transmitting, to the network node, a sequence via a resource associated with the set of SSB transmission resources, wherein the resource is mapped to an SSB of the set of SSBs associated with a highest signal quality metric associated with the set of SSBs. The method may include receiving, from the network node, a feedback communication that indicates successful reception of the sequence and indicates that one or more subsequent downlink transmissions are associated with a TCI state associated with the SSB.

Some aspects described herein relate to a method of wireless communication performed by a network node. The method may include transmitting, to a UE, a set of SSBs that are respectively mapped to a set of SSB transmission resources. The method may include receiving, from the UE, a sequence via a resource associated with the set of SSB transmission resources, wherein the resource is mapped to an SSB of the set of SSBs associated with a highest signal quality metric associated with the set of SSBs. The method may include transmitting, to the UE, a feedback communication that indicates successful reception of the sequence and indicates that one or more subsequent downlink transmissions are associated with a TCI state associated with the SSB.

Some aspects described herein relate to a non-transitory computer-readable medium that stores a set of instructions for wireless communication by a UE. The set of instructions, when executed by one or more processors of the UE, may cause the UE to receive, from a network node while monitoring for a WUS from the network node, a set of SSBs that are respectively mapped to a set of SSB transmission resources. The set of instructions, when executed by one or more processors of the UE, may cause the UE to transmit, to the network node, a sequence via a resource associated with the set of SSB transmission resources, wherein the resource is mapped to an SSB of the set of SSBs associated with a highest signal quality metric associated with the set of SSBs. The set of instructions, when executed by one or more processors of the UE, may cause the UE to receive, from the network node, a feedback communication that indicates successful reception of the sequence and indicates that one or more subsequent downlink transmissions are associated with a TCI state associated with the SSB.

Some aspects described herein relate to a non-transitory computer-readable medium that stores a set of instructions for wireless communication by a network node. The set of instructions, when executed by one or more processors of the network node, may cause the network node to transmit, to a UE, a set of SSBs that are respectively mapped to a set of SSB transmission resources. The set of instructions, when executed by one or more processors of the network node, may cause the network node to receive, from the UE, a sequence via a resource associated with the set of SSB transmission resources, wherein the resource is mapped to an SSB of the set of SSBs associated with a highest signal quality metric associated with the set of SSBs. The set of instructions, when executed by one or more processors of the network node, may cause the network node to transmit, to the UE, a feedback communication that indicates successful reception of the sequence and indicates that one or more subsequent downlink transmissions are associated with a TCI state associated with the SSB.

Some aspects described herein relate to an apparatus for wireless communication. The apparatus may include means for receiving, from a network node while monitoring for a WUS from the network node, a set of SSBs that are respectively mapped to a set of SSB transmission resources. The apparatus may include means for transmitting, to the network node, a sequence via a resource associated with the set of SSB transmission resources, wherein the resource is mapped to an SSB of the set of SSBs associated with a highest signal quality metric associated with the set of SSBs. The apparatus may include means for receiving, from the network node, a feedback communication that indicates successful reception of the sequence and indicates that one or more subsequent downlink transmissions are associated with a TCI state associated with the SSB.

Some aspects described herein relate to an apparatus for wireless communication. The apparatus may include means for transmitting, to a UE, a set of SSBs that are respectively mapped to a set of SSB transmission resources. The apparatus may include means for receiving, from the UE, a sequence via a resource associated with the set of SSB transmission resources, wherein the resource is mapped to an SSB of the set of SSBs associated with a highest signal quality metric associated with the set of SSBs. The apparatus may include means for transmitting, to the UE, a feedback communication that indicates successful reception of the sequence and indicates that one or more subsequent downlink transmissions are associated with a TCI state associated with the SSB.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples of channel state information reference signal (CSI-RS) beam management procedures, in accordance with the present disclosure.

FIG. 4 is a diagram illustrating an example of a synchronization signal (SS) hierarchy, in accordance with the present disclosure.

FIG. 5 is a diagram illustrating an example of a low-power wakeup radio (LP-WUR) and a low-power wakeup signal (LP-WUS), in accordance with the present disclosure.

FIG. 6 is a diagram illustrating an example of a simple waveform modulation, in accordance with the present disclosure.

FIG. 7 is a diagram illustrating an example of a user equipment (UE) moving while operating in a low-power mode, in accordance with the present disclosure.

FIG. 8 is a diagram illustrating an example associated with beam management in accordance with a low-power mode, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, one or more wireless devices may perform beam management and/or beam selection techniques in accordance with facilitating wireless communications. For example, beam selection between a network node and a user equipment (UE) may be a process that enables communication quality, particularly in environments with beamforming. In some examples, the network node may transmit a set of synchronization signal blocks (SSBs) across multiple beams, with each beam covering a specific spatial direction (e.g., each beam is associated with one or more spatial parameters such as a transmission configuration indicator (TCI) state and/or a quasi co-location (QCL) parameter, among other examples). The UE may monitor and measure the signal quality of the received SSBs, using metrics such as reference signal received power (RSRP) or signal-to-interference-plus-noise ratio (SINR). After evaluating the measurements, the UE may select the beam associated with the SSB that exhibits the highest signal quality of the set of SSBs. This selected beam may serve as a link for communication between the network node and the UE. Therefore, the beam selection process may enable the UE to connect to the network node via the beam best suited based on location and/or environment of the UE.

Additionally, the UE may be equipped with a communication system that includes a main radio and a low-power wakeup radio (LP-WUR) to reduce power consumption and enable low latency. For example, the UE may generally use the main radio to transmit and/or receive user data, where the main radio may be turned off or operated in a deep sleep state unless there is user data to transmit and/or receive. Furthermore, the LP-WUR may serve as a wakeup receiver for the main radio, and the LP-WUR may be active and monitoring for a low-power wakeup signal (LP-WUS) while the main radio is off or in the deep sleep state. For example, if there is no user data to be provided, the main radio may be off or operated in the deep sleep state and the LP-WUR may monitor for an LP-WUS (for example, continuously, or periodically in monitoring occasions that are separated in time). Furthermore, if there is user data for the main radio, the LP-WUR may receive an LP-WUS (such as from the network node) and may provide a trigger to wake or otherwise activate the main radio based on detecting the LP-WUS. Accordingly, the main radio may then transmit and/or receive user data. In some examples, the network node may transmit the LP-WUS using the beam selected as part of the beam selection procedures.

In some cases, a beam quality associated with one or more of the beams at the network node may change over time. For example, if the UE moves from a first position to a second position, the beam at the network node that may be best for communications with the UE may change. Additionally, or alternatively, one or more other characteristics may result in a change in beam quality for one or more beams at the network node. For instance, the one or more other characteristics may include one or more of physical obstacles, adverse weather conditions, or interference from other UEs and/or other network nodes. Therefore, to maintain beam quality, the network node and UE may perform periodic beam management procedures. For instance, the network node may periodically transmit SSBs across the set of beams at the network node, and the UE may periodically measure the SSBs to ensure that the beam used for communications between the UE and network node is associated with the SSB measured to have the highest signal quality.

In some cases, however, while the UE operates in a low-power mode, the UE and network node may be unaware of changes to beam quality. For example, if the main radio of the UE is off, the LP-WUR may be unable to decode and/or process the SSBs received as part of beam management. Therefore, the UE may be unable to keep the network node up to date with current beam quality metrics associated with the network beams and, as a result, the network node may communicate downlink transmissions in accordance with out-of-date beam quality information. Additionally, if the network node transmits an LP-WUS to wake up the main radio of the UE using out-of-date beam quality information, a signal quality associated with the LP-WUS may be reduced. Such reductions in signal quality may result in the UE being unable to receive the LP-WUS, which may result in the UE not turning on the main radio and missing one or more downlink transmissions from the network node. Therefore, communications in accordance with out-of-date beam quality information may result in wireless retransmissions, which may increase latency, signaling overhead, and power expenditure at both the UE and the network node.

Various aspects relate generally to beam management while the UE operates in accordance with a low-power mode. Some aspects more specifically relate to the UE receiving a set of SSBs (and/or low-power synchronization signals (LP-SSs)) while monitoring for an LP-WUS. For example, the UE may receive the set of SSBs via the LP-WUR to measure a signal quality metric associated with each of the SSBs (without decoding and/or processing the set of SSBs). Additionally, the network node may configure the UE with a sequence and a set of sequence reception resources to indicate which SSB is associated with the highest signal quality. For example, the set of sequence reception resources may be respectively mapped to the set of SSBs, such that the UE may transmit the sequence via the sequence reception resource mapped to the SSB measured to have the highest signal quality metric. In some aspects, the UE may be capable of transmitting the sequence via a simple waveform using an associated low-power transmitter (LP-transmitter). That is, the UE may transmit the sequence using the LP-transmitter while the main radio is off. In some aspects, the network node may receive the sequence and understand that the sequence reception resource used for the sequence transmission indicates which SSB has the highest signal quality metric. Therefore, the network node may transmit a feedback message that indicates successful reception of the sequence and further indicates that one or more subsequent downlink transmissions may be associated with the beam associated (or quasi co-located) with the SSB that has the highest signal quality. In some examples, the feedback communication may be a simple on-off keying (OOK) modulated waveform (such as an LP-WUS) such that the UE may receive the feedback communication via the LP-WUR.

Particular aspects of the subject matter described in this disclosure can be implemented to realize one or more of the following potential advantages. In some examples, the described techniques can be used to perform beam management without using the main radio of the UE. For example, the UE may use the LP-WUR to receive SSBs or LP-SSs and measure signal quality rather than turning on the main radio, which may reduce power expenditure at the UE. Additionally, by indicating the SSB or LP-SS with the highest signal quality based on selecting the corresponding sequence reception resource, the UE may transmit the sequence using a simple waveform, which may reduce the number of time and frequency resources used for transmission. Additionally, the UE may transmit the sequence using the LP-transmitter (rather than the main radio), which may reduce power expenditure and latency associated with turning on the main radio. Additionally, by using the LP-WUR and LP-transmitter to communicate information associated with beam management, the UE may periodically update the network node with the best beam for communication while operating in a low-power mode, which may increase the reliability of wireless communications while decreasing power expenditure.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

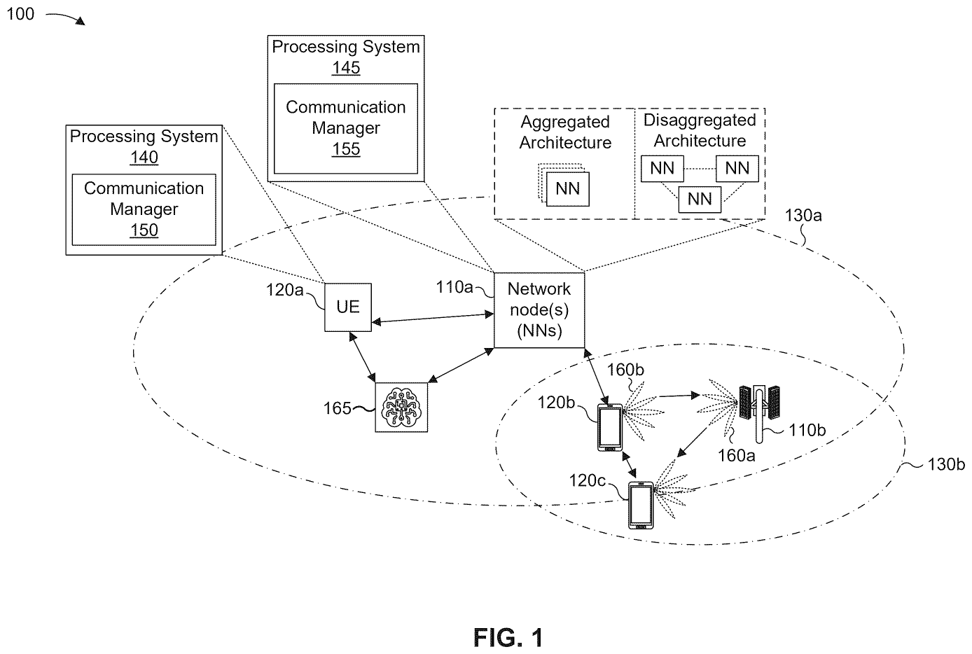

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally, or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally, or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

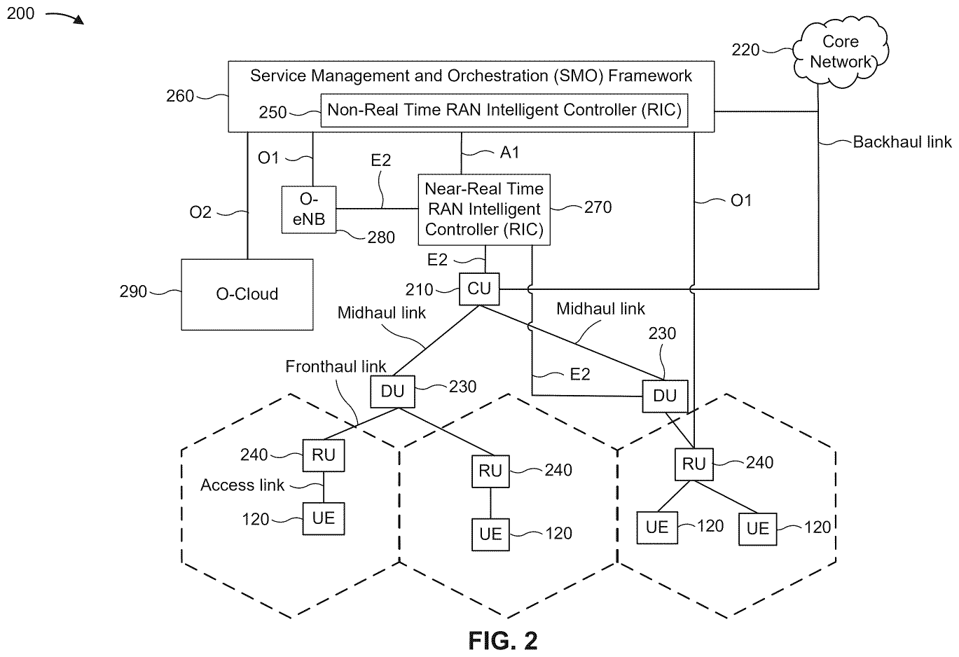

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-RSRP parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition

operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a TCI state and/or a QCL parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally, or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally, or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally, or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may receive, from a network node while monitoring for a WUS from the network node, a set of SSBs that are respectively mapped to a set of SSB transmission resources; transmit, to the network node, a sequence via a resource associated with the set of SSB transmission resources, wherein the resource is mapped to an SSB of the set of SSBs associated with a highest signal quality metric associated with the set of SSBs; and receive, from the network node, a feedback communication that indicates successful reception of the sequence and indicates that one or more subsequent downlink transmissions are associated with a TCI state associated with the SSB; the feedback communication may also indicate that the TCI state of one or more subsequent downlink transmissions has the SSB as the quasi co-located reference signal. Additionally, or alternatively, the communication manager 150 may perform one or more other operations described herein.

In some aspects, the network node 110 may include a communication manager 155. As described in more detail elsewhere herein, the communication manager 155 may transmit, to a UE, a set of SSBs that are respectively mapped to a set of SSB transmission resources; receive, from the UE, a sequence via a resource associated with the set of SSB transmission resources, wherein the resource is mapped to an SSB of the set of SSBs associated with a highest signal quality metric associated with the set of SSBs; and transmit, to the UE, a feedback communication that indicates successful reception of the sequence and indicates that one or more subsequent downlink transmissions are associated with a TCI state associated with the SSB. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

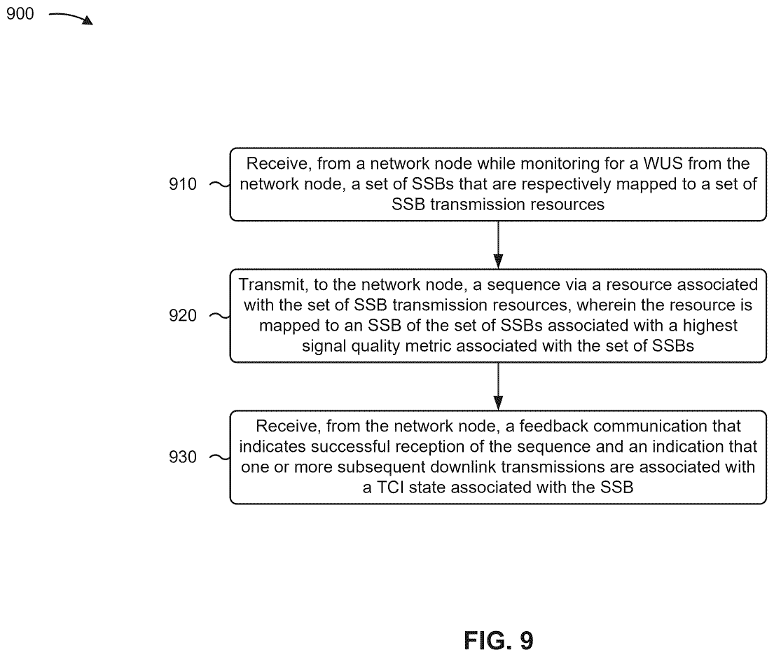

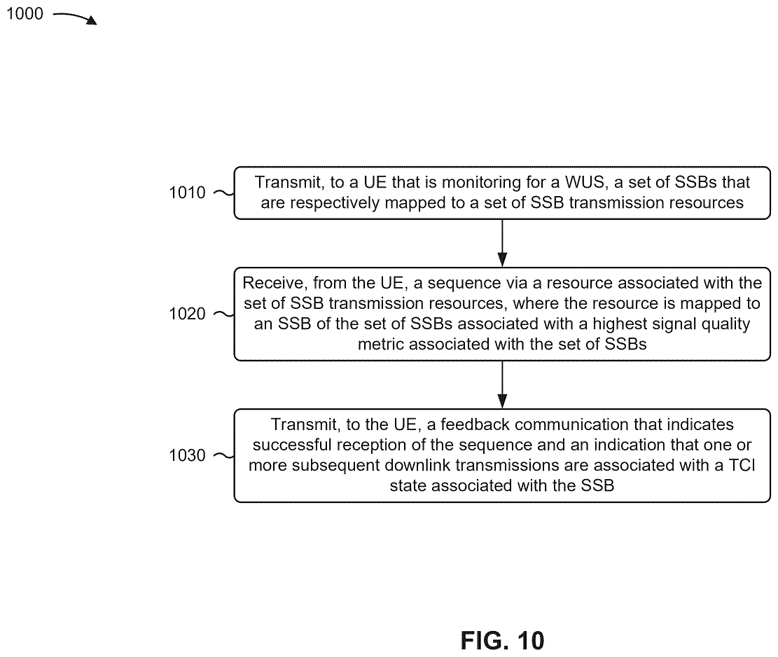

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with beam management in accordance with a low-power mode, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

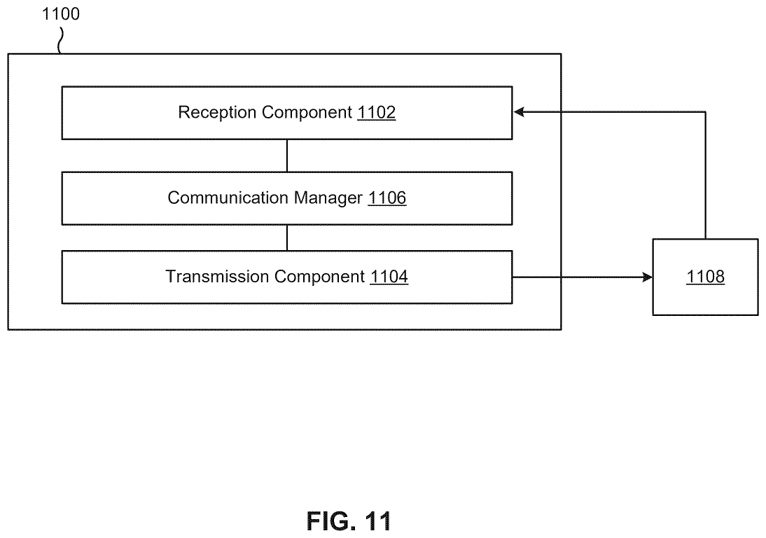

In some aspects, a UE includes means for receiving, from a network node while monitoring for a WUS from the network node, a set of SSBs that are respectively mapped to a set of SSB transmission resources; means for transmitting, to the network node, a sequence via a resource associated with the set of SSB transmission resources, wherein the resource is mapped to an SSB of the set of SSBs associated with a highest signal quality metric associated with the set of SSBs; and/or means for receiving, from the network node, a feedback communication that indicates successful reception of the sequence and indicates that one or more subsequent downlink transmissions are associated with a TCI state associated with the SSB. The means for the UE to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

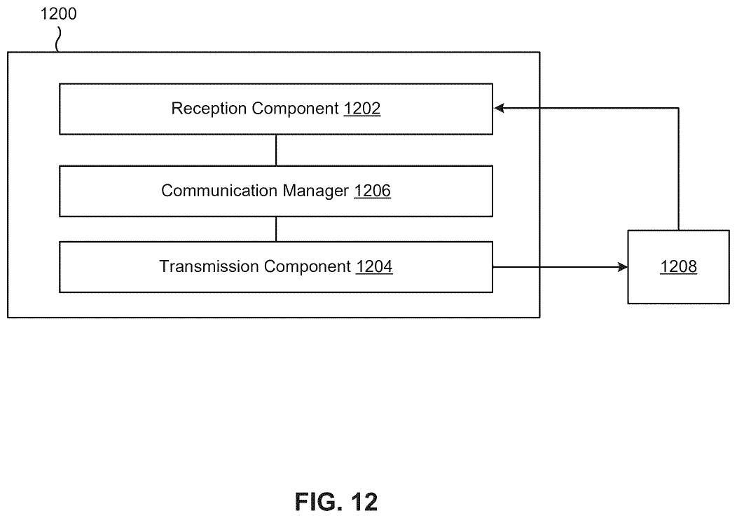

In some aspects, a network node includes means for transmitting, to a UE, a set of SSBs that are respectively mapped to a set of SSB transmission resources; means for receiving, from the UE, a sequence via a resource associated with the set of SSB transmission resources, wherein the resource is mapped to an SSB of the set of SSBs associated with a highest signal quality metric associated with the set of SSBs; and/or means for transmitting, to the UE, a feedback communication that indicates successful reception of the sequence and indicates that one or more subsequent downlink transmissions are associated with a TCI state associated with the SSB. The means for the network node to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

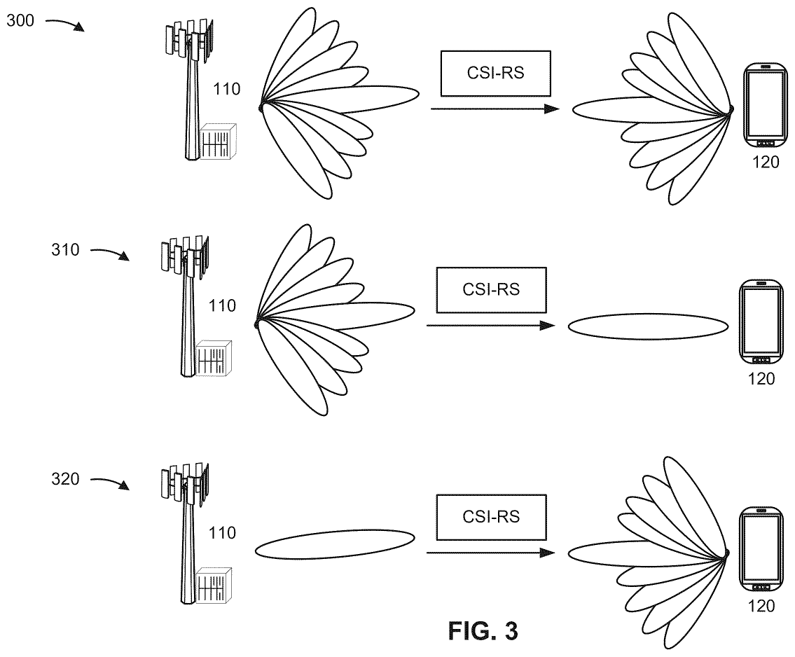

FIG. 3 is a diagram illustrating examples 300, 310, and 320 of CSI-RS beam management procedures, in accordance with the present disclosure. As shown in FIG. 3, examples 300, 310, and 320 include a UE 120 in communication with a network node 110 in a wireless network (e.g., wireless network 100). However, the devices shown in FIG. 3 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 3, example 300 may include a network node 110 (e.g., one or more network node devices such as an RU, a DU, and/or a CU, among other examples) and a UE 120 communicating to perform beam management using CSI-RSs. Example 300 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 300 has been described in connection with CSI-RSs, the first beam management process may also use SSBs for beam management in a similar manner as described above.

As shown in FIG. 3, example 310 may include a network node 110 and a UE 120 communicating to perform beam management using CSI-RSs. Example 310 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 3 and example 310, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 3 is provided as an example of beam management procedures. Other examples of beam management procedures may differ from what is described with respect to FIG. 3. For example, the UE 120 and the network node 110 may perform the third beam management procedure before performing the second beam management procedure, and/or the UE 120 and the network node 110 may perform a similar beam management procedure to select a UE transmit beam.

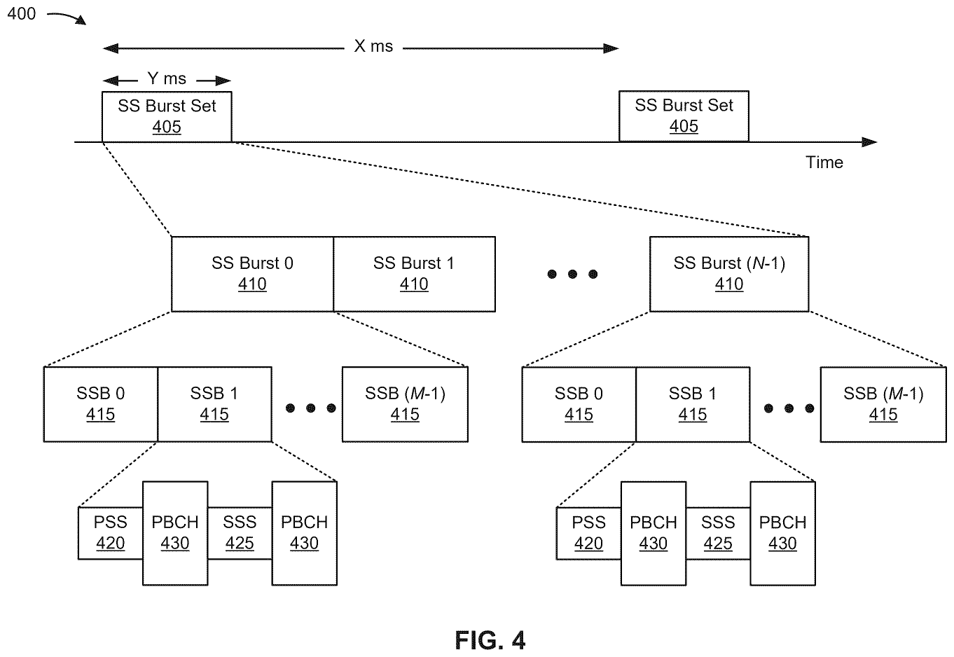

FIG. 4 is a diagram illustrating an example 400 of a synchronization signal (SS) hierarchy, in accordance with the present disclosure. As shown in FIG. 4, the SS hierarchy may include an SS burst set 405, which may include multiple SS bursts 410, shown as SS burst 0 through SS burst N-1, where N is a maximum number of repetitions of the SS burst 410 that may be transmitted by one or more network nodes. As further shown, each SS burst 410 may include one or more SS blocks (SSBs) 415, shown as SSB 0 through SSB M-1, where M is a maximum number of SSBs 415 that can be carried by an SS burst 410. In some aspects, different SSBs 415 may be beam-formed differently (e.g., transmitted using different beams), and may be used for cell search, cell acquisition, beam management, and/or beam selection (e.g., as part of an initial network access procedure). An SS burst set 405 may be periodically transmitted by a wireless node (e.g., a network node 110), such as every X milliseconds, as shown in FIG. 4. In some aspects, an SS burst set 405 may have a fixed or dynamic length, shown as Y milliseconds in FIG. 4. In some cases, an SS burst set 405 or an SS burst 410 may be referred to as a discovery reference signal (DRS) transmission window or an SSB measurement time configuration (SMTC) window.

In some aspects, an SSB 415 may include resources that carry a primary synchronization signal (PSS) 420, a secondary synchronization signal (SSS) 425, and/or a physical broadcast channel (PBCH) 430. In some aspects, multiple SSBs 415 are included in an SS burst 410 (e.g., with transmission on different beams), and the PSS 420, the SSS 425, and/or the PBCH 430 may be the same across each SSB 415 of the SS burst 410. In some aspects, a single SSB 415 may be included in an SS burst 410. In some aspects, the SSB 415 may be at least four symbols (e.g., OFDM symbols) in length, where each symbol carries one or more of the PSS 420 (e.g., occupying one symbol), the SSS 425 (e.g., occupying one symbol), and/or the PBCH 430 (e.g., occupying two symbols). In some aspects, an SSB 415 may be referred to as an SS/PBCH block.

In some aspects, the symbols of an SSB 415 are consecutive, as shown in FIG. 4. In some aspects, the symbols of an SSB 415 are non-consecutive. Similarly, in some aspects, one or more SSBs 415 of the SS burst 410 may be transmitted in consecutive radio resources (e.g., consecutive symbols) during one or more slots. Additionally, or alternatively, one or more SSBs 415 of the SS burst 410 may be transmitted in non-consecutive radio resources.

In some aspects, the SS bursts 410 may have a burst period, and the SSBs 415 of the SS burst 410 may be transmitted by a wireless node (e.g., a network node 110) according to the burst period. In this case, the SSBs 415 may be repeated during each SS burst 410. In some aspects, the SS burst set 405 may have a burst set periodicity, whereby the SS bursts 410 of the SS burst set 405 are transmitted by the wireless node according to the fixed burst set periodicity. In other words, the SS bursts 410 may be repeated during each SS burst set 405.

In some aspects, an SSB 415 may include an SSB index, which may correspond to a beam used to carry the SSB 415. A UE 120 may monitor for and/or measure SSBs 415 using different receive (Rx) beams during an initial network access procedure and/or a cell search procedure, among other examples. Based at least in part on the monitoring and/or measuring, the UE 120 may indicate one or more SSBs 415 with a best signal parameter (e.g., an RSRP parameter) to a network node 110 (e.g., directly or via one or more other network nodes). The network node 110 and the UE 120 may use the one or more indicated SSBs 415 to select one or more beams to be used for communication between the network node 110 and the UE 120 (e.g., for a random access channel (RACH) procedure). Additionally, or alternatively, the UE 120 may use the SSB 415 and/or the SSB index to determine a cell timing for a cell via which the SSB 415 is received (e.g., a serving cell).

As indicated above, FIG. 4 is provided as an example. Other examples may differ from what is described with regard to FIG. 4.

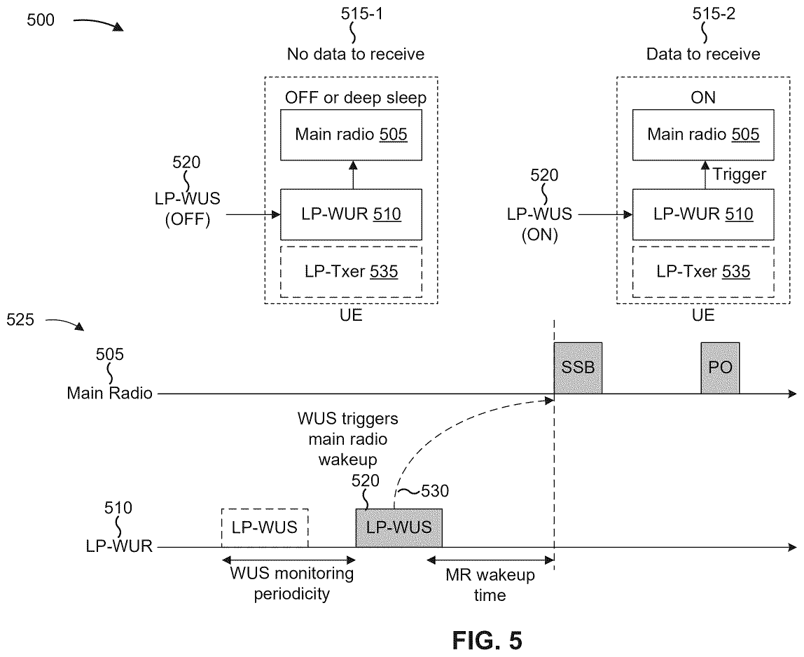

FIG. 5 is a diagram illustrating an example 500 of an LP-WUR and an LP-WUS, in accordance with the present disclosure. As shown in FIG. 5, a UE (such as UE 120) may be equipped with a communication system that includes a main radio (illustrated as “MR”) 505 and an LP-WUR 510 to reduce power consumption and enable low latency. For example, power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. Accordingly, as shown in FIG. 5, the UE may be equipped with the LP-WUR 510, which may be considered a companion receiver that can be used with a main radio 505 to reduce power consumption and latency.

For example, in some aspects, the UE may generally use the main radio 505 to transmit and/or receive user data, and the main radio 505 may be turned off or operated in a deep sleep state unless there is user data to transmit and/or receive. Furthermore, the LP-WUR 510 may serve as a simple wakeup receiver for the main radio 505, and the LP-WUR 510 may be active and monitoring for an LP-WUS while the main radio 505 is off or in the deep sleep state. For example, reference number 515-1 depicts a first state associated with the main radio 505 and the LP-WUR 510 where there is no user data to be provided to the main radio 505. In such cases, the main radio 505 may be off or operated in the deep sleep state unless there is user data to transmit, and the LP-WUR 510 may monitor for an LP-WUS (for example, continuously, or periodically in monitoring occasions that are separated in time). Furthermore, reference number 515-2 depicts a second state associated with the main radio 505 and the LP-WUR 510 where there is user data for the main radio 505. In such cases, the LP-WUR 510 may receive an LP-WUS 520 (such as from a network node 110) and may provide a trigger to wake or otherwise activate the main radio 505 based on detecting the LP-WUS 520. Accordingly, the main radio 505 may then transmit and/or receive user data.

In general, the LP-WUR 510 may consume very little power (for example a target power consumption less than 100 microwatts (μW) in the active state), which may be achieved using simple modulation schemes (for example, on-off keying (OOK)), a narrow bandwidth (for example, less than 5 MHz), and/or other suitable techniques. In this way, the LP-WUR 510 can be used to reduce the time that the main radio 505 spends in an on state and/or may avoid unnecessarily waking the main radio 505 from the off or deep sleep state when there is no user data to transmit or receive, which tends to be costly from a power consumption perspective. Furthermore, because the LP-WUR 510 has a very low-power consumption, the LP-WUR 510 can be used to frequently or continuously perform LP-WUS monitoring, which may improve latency because the main radio 505 can be woken up when there is user data that the main radio 505 needs to receive. For example, the LP-WUR 510 may not suffer from the latency versus power efficiency tradeoff associated with duty cycling schemes, such as DRX. Furthermore, in addition to performing LP-WUS monitoring, which may be used for paging reception, the LP-WUR 510 may monitor a low-power synchronization signal (LP-SS) for time and frequency tracking and radio resource management (RRM) measurement. In this way, by monitoring the LP-SS, serving cell and/or neighbor cell monitoring can be offloaded from the main radio 505 to the LP-WUR 510 to reduce how often the main radio 505 is woken up, which can further reduce power consumption.

In some aspects, the LP-WUR 510 may include an OOK WUR (also referred to as an envelope detector (ED) WUR). An OOK WUR may only detect the amplitude (such as the magnitude) of a received signal. A UE that uses an OOK WUR may detect the phase of a received signal by activating the main radio 505.

In some aspects, the LP-WUR 510 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some aspects, as shown by reference number 525, one application of the LP-WUR 510 is to monitor the LP-WUS 520 for paging monitoring, which can be used to reduce unnecessary paging reception performed by the main radio 505. For example, as shown in FIG. 5, the LP-WUR 510 may be configured to monitor for an LP-WUS 520 (while the main radio 505 is off or in a deep sleep state) according to a WUS monitoring periodicity. For example, the LP-WUR 510 may monitor for the LP-WUS 520 in periodic LP-WUS monitoring occasions that are spaced in time according to the WUS monitoring periodicity. Alternatively, although not explicitly shown in FIG. 5, the LP-WUR 510 may be configured to continuously monitor for the LP-WUS 520. In general, a network node may transmit an LP-WUS 520 to a UE only in cases where there is a paging message that needs to be sent to the UE while the UE is in an idle or inactive state (such as an RRC idle or RRC inactive state). In such cases, as shown by reference number 530, the LP-WUR 510 may receive and detect the LP-WUS 520, which may trigger the LP-WUR 510 to wake up the main radio 505. In some aspects, the LP-WUS 520 may be a sequence-based WUS, which may include a predefined set of sequences (implemented, for example, using OOK modulation and/or phase modulation). As shown, the main radio 505 may wake up after a main radio wakeup time, and may then start to monitor one or more synchronization signal block (SSB) transmissions to obtain synchronization with the network node before monitoring and receiving the paging message in a subsequent PO. Otherwise, in cases where the LP-WUR 510 does not detect the LP-WUS 520, the main radio 505 may remain in the deep sleep state to save power.

In some examples, as shown in FIG. 5, the UE may optionally include an LP-transmitter 535. For example, UE may be equipped with the LP-transmitter 535, which may be considered a companion transmitter that can be used in addition to or alternatively to the main radio 505 to reduce power consumption and latency.

Furthermore, the LP-transmitter 535 may serve as a simple wakeup transmitter for the main radio 505, and the LP-transmitter 535 may be active and transmit simple waveforms (e.g., one or more of OOK, binary phase shifting (BPSK), amplitude shift keying (ASK), frequency shift keying (FSK), pulse position modulation (PPM), gaussian frequency shift keying (GFSK), differential binary phase shift keying (DBPSK), pulse amplitude modulation (PAM), or chirp spread spectrum (CSS)) while the main radio 505 is off or in the deep sleep state. For instance, if the main radio 505 is off or operated in the deep sleep state, the UE may use the LP-transmitter 535 to transmit one or more simple waveforms, which may reduce energy consumption associated with operating the main radio 505 and reduce latency associated with turning the main radio 505 to the on state. In some examples, the LP-transmitter 535 may not be limited to OOK transmissions. For instance, the UE may use the LP-transmitter 535 to transmit OFDM transmissions during OFDM symbols. In some examples, the LP-transmitter 535 may be a separate component from the LP-WUR 510. In some examples, the LP-transmitter 535 and the LP-WUR 510 may be a single component, such as a low-power transceiver (LP-Tx/Rx) capable of transmitting and receiving simple waveforms if the main radio 505 is off or operated in the deep sleep state.

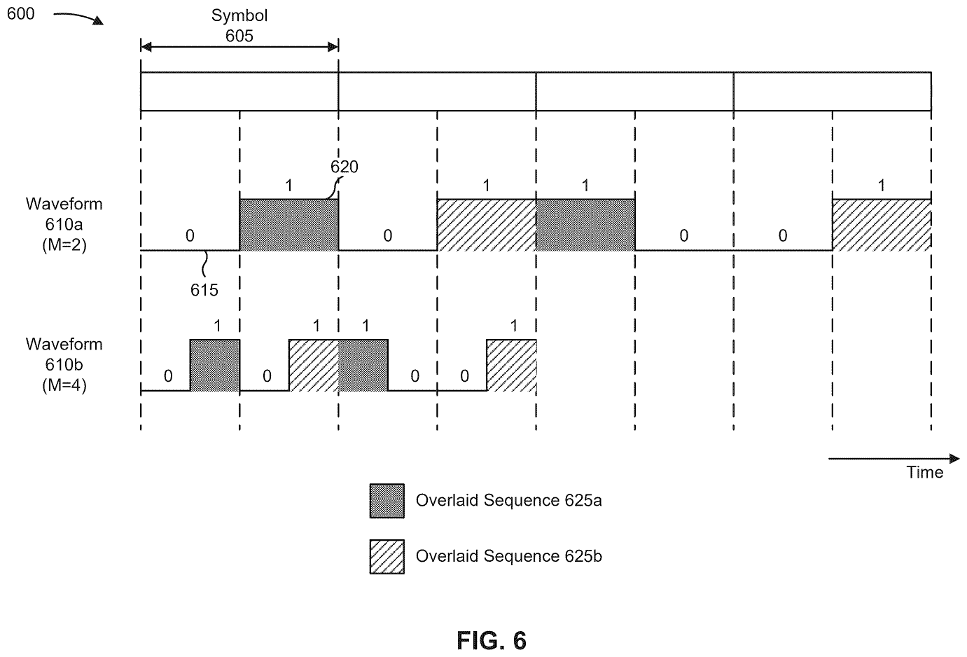

FIG. 6 is a diagram illustrating an example 600 of a simple waveform modulation, in accordance with the present disclosure. Example 600 may implement or be implemented by one or more of FIGS. 1 through 5. For instance, example 600 shows waveforms 610a and 610b, which may be examples of OOK waveforms as described with reference to FIG. 5. Additionally, a UE (such as the UE 120) may transmit and/or receive the waveforms 610a and/or 610b using one or more of the main radio 505, the LP-WUR 510, or the LP-transmitter 535 as described with reference to FIG. 5.

As shown in FIG. 6, the waveforms 610a and 610b may span one or more symbols 605 (e.g., one or more OFDM symbols). As described elsewhere herein, an OOK waveform is a sequence of high power and/or amplitude durations and low-power and/or amplitude durations. For instance, as shown in example 600, the low-power durations may correspond to an off duration 615, where the power and/or amplitude of the waveform 610 is below a power threshold. In some examples, the off duration 615 may be associated with and/or indicate a first bit value (e.g., ‘0’). Additionally, the high power durations may correspond to an on duration 620, where the power and/or amplitude of the waveform 610 is above the power threshold. In some examples, the on duration 620 may be associated with and/or indicate a second bit value (e.g., ‘1’). Therefore, each off duration 615 and each on duration 620 of a waveform 610 may convey and/or indicate a bit of information.

As shown in FIG. 6, the waveforms 610a and 610b may include one or more overlaid sequences 625 (e.g., an overlaid sequence 625a and 625b). For instance, an overlaid sequence 625 may be an example of an overlaid OFDM sequence incorporated within one or more on durations 620 of an OOK waveform, which may enable additional data transmission while maintaining the simplicity and power efficiency of OOK. In such examples of overlaid sequences 625, when a waveform 610 is active (representing the on duration 620), an OFDM sequence can be superimposed onto the signal of the waveform 610. In some examples, an overlaid sequence 625 may include and/or be associated with multiple frequency subcarriers that may each carry a portion of data included in an overlaid sequence 625. In some examples, the respective portions of data may be transmitted/received concurrently and/or orthogonally to reduce interference. Therefore, the inclusion of overlaid sequences 625 may leverage the on durations 620 of the OOK waveform to embed more complex modulation schemes (e.g., BPSK, quadrature phase shift keying (QPSK), or higher-order QAM on the subcarriers), which may increase data throughput of the OOK waveform. Additionally, the presence of an overlaid sequence 625 may not disrupt OOK operations, as the overall power envelope remains detectable for binary decisions. In some examples, overlaid sequences 625 may be advantageous for systems associated with both energy efficiency and higher data rates, such as the UE operating in a low-power mode (e.g., the main radio 505 is off or in deep sleep). In some examples, an overlaid sequence 625 may be an example of a Gold sequence, an M sequence, a computer searched sequence, or a Zadoff Chu sequence.

Additionally, as illustrated in FIG. 6, the waveforms 610a and 610b may include multiple overlaid sequences 625. For instance, the overlaid sequence 625a may include and/or indicate first data information and the overlaid sequence 625b may include and/or indicate second data information.

In some examples, the waveforms 610 may include repetitions of an overlaid sequence 625. For instance, the waveform 610a may include a first repetition of the overlaid sequence 625a in a first symbol 605 and a second repetition of the overlaid sequence 625a in a third symbol 605. Additionally, the waveform 610a may include a first repetition of the overlaid sequence 625b in a second symbol 605 and a second repetition of the overlaid sequence 625b in a fourth symbol 605. In some examples, the waveforms 610 may partition an overlaid sequence 625 into multiple portions. For instance, the waveform 610a may include a first portion of the first data information of the overlaid sequence 625a in the first symbol 605 and a second portion of the first data information of the overlaid sequence 625a in the third symbol 605. Additionally, the waveform 610a may include a first portion of the second data information of the overlaid sequence 625b in the second symbol 605 and a second portion of the second data information of the overlaid sequence 625b in the fourth symbol 605.

As shown in FIG. 6, the waveforms 610a and 610b may be associated with an integer value of M. For instance, in example 600, the waveforms 610a and 610b may be OOK-4 waveforms. In some examples, OOK-4 waveforms may convey and/or indicate M bits of information per symbol 605 (e.g., using an amplitude associated with the OOK-4 waveform). For example, the waveform 610a may be an OOK-4 waveform with an M value equal to two, and therefore the waveform 610a may indicate two bits of information per symbol 605 (e.g., not including information indicated via an overlaid sequence 625). Additionally, the waveform 610b may be an OOK-4 waveform with an M value equal to four, and therefore the waveform 610b may indicate four bits of information per symbol 605 (e.g., not including information indicated via an overlaid sequence 625).

In some other examples, the waveforms 610 may be a different type of OOK, such as OOK-1. For example, OOK-1 waveforms may convey and/or indicate 1 bit of information per symbol 605 (e.g., using an amplitude associated with the OOK-1 waveform). In some other examples, the waveforms 610 may be any other type of simple waveform described elsewhere herein.

In some examples, the waveforms 610 may be a low-power signal, such as an LP-SS and/or an LP-WUS, as described elsewhere herein. For instance, if the waveform 610a is an LP-WUS in FR1 with an SCS of 30 kHz, then the waveform 610a may include 11 physical resource blocks (PRBs) in the frequency domain.

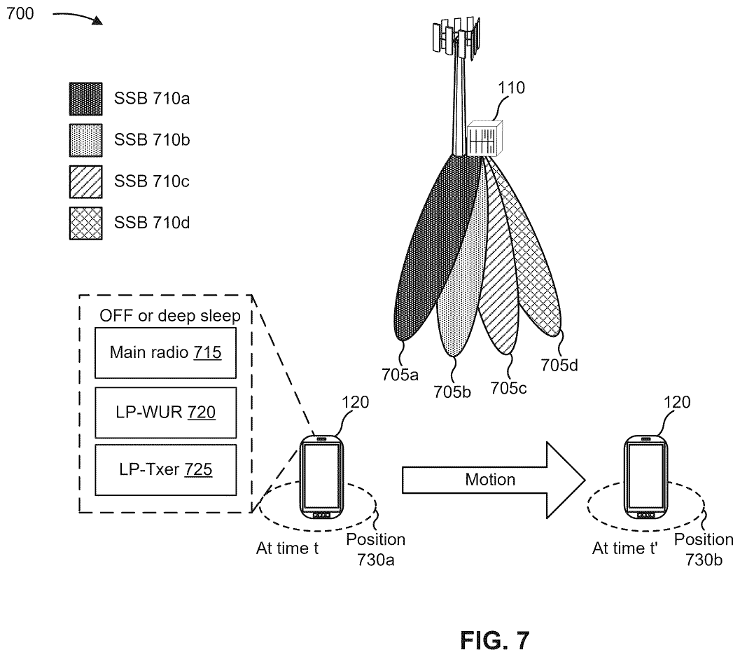

FIG. 7 is a diagram illustrating an example 700 of a UE moving while operating in a low-power mode, in accordance with the present disclosure. Example 700 may implement or be implemented by one or more of FIGS. 1 through 6. For instance, the UE 120 may include a main radio 715, an LP-WUR 720, and an LP-transmitter 725, which may be respective examples of the main radio 505, the LP-WUR 510, and the LP-transmitter 535, as described with reference to FIG. 5. Additionally, beams 705a, 705b, 705c, and 705d may be examples of network node 110 beams as described elsewhere herein. Additionally, SSBs 710a, 710b, 710c, and 710d may be examples of SSBs as described elsewhere herein (e.g., SSBs 415). In some examples, each beam 705 may be respectively identified via one or more spatial parameters, such as a TCI state and/or a QCL parameter, among other examples.

As shown in FIG. 7, each beam 705 may be associated with and/or mapped to an SSB 710. For example, the beam 705a may be mapped to the SSB 710a, the beam 705b may be mapped to the SSB 710b, the beam 705c may be mapped to the SSB 710c, and the beam 705d may be mapped to the SSB 710d. In some examples, the UE 120 and the network node 110 may communicate via beam 705a while the UE 120 is at a position 730a (at time t). For instance, as part of an initial beam acquisition operation (as described elsewhere herein), the network node 110 may respectively transmit the set of SSBs 710 via the respective beams 705. In accordance with receiving the set of SSBs 710, the UE 120 may measure a signal quality metric for each of the set of SSBs to identify a best beam 705 for communication between the UE 120 and the network node 110. For instance, with reference to FIG. 6, the UE 120 may measure a signal quality metric for each of SSBs 710a through 710d at the position 730a and may determine that the SSB 710a is associated with the highest signal quality metric. Therefore, the UE 120 may transmit an indication of SSB 710a, and the network node 110 may determine to communicate subsequent downlink transmissions using the beam 705a. In some examples, the signal quality metric measured by the UE 120 may be one or more of RSRP, RSRQ, SINR, signal-to-noise ratio (SNR), RSSI, CQI, bit error rate (BER), block error rate (BLER), error vector magnitude (EVM), or spectral efficiency (SE).

In some cases, the best beam 705 for communications between the UE 120 and the network node 110 may change. For instance, as shown in FIG. 7, the UE 120 may physically move in the spatial domain, such that at time t′ the UE 120 may be at a position 730b. Therefore, the UE 120 and network node 110 may perform periodic transmissions of the SSBs 710 for the UE 120 to determine if there is a change in which SSB 710 is associated with the highest signal quality metric.

In some examples, if the UE 120 is operating in a low-power mode between t and t′, then the network node 110 may be unaware of a change in beam quality. In one example, the main radio 715 may be turned off or operated in a deep sleep such that the UE 120 may use the LP-WUR 720 to monitor and/or receive one or more LP-WUSs or one or more LP-SSs. Additionally, while the main radio 715 is turned off or operated in a deep sleep, the UE 120 may refrain from receiving and/or decoding the SSBs 710 to conserve energy, and as a result, may refrain from transmitting updates in SSB 710 signal quality measurements. However, if between time t and time t′ the UE 120 does not transmit updates in SSB 710 signal quality, the network node 110 may transmit an LP-WUS using beam 705a while the UE 120 is at position 730b (e.g., based on the UE 120 indicating that SSB 710a has a highest signal quality metric, before turning off the main radio 715). Additionally, or alternatively to the UE 120 moving from the position 730a to the position 730b, one or more other characteristics may result in a change in beam quality for one or more of the beams 705. For instance the one or more other characteristics may include one or more of physical obstacles (e.g., buildings, trees, or vehicles obstructing the signal path), adverse weather conditions (e.g., rain or fog causing attenuation), interference from other UEs and/or other network nodes, beam misalignment caused by mobility or environmental shifts, changes in network load or resource allocation, multipath effects altering signal coherence, or hardware or calibration issues at the UE 120 and/or the network node 110.

In other words, the network node 110 may transmit LP-WUSs and/or LP-SSs using out-of-date beam quality information based on the UE 120 moving while the main radio 715 is turned off or operated in a deep sleep. In some examples, such transmission of an LP-WUS/LP-SS using out-of-date beam quality information may reduce the signal quality of the LP-WUS/LP-SS. For example, at the position 730a and time t, the UE 120 measured beam 705a as the highest quality beam, but at the position 730b, a quality associated with beam 705a may decrease while a beam quality with the beam 705c and/or the beam 705d may increase. Therefore, transmissions using beam 705a while the UE 120 is at position 730b may be associated with a signal quality lower than a highest possible signal quality across the set of beams 705. Such reductions in signal quality may result in the UE 120 being unable to receive one or more wireless signals from the network node 110, which may increase latency, signaling overhead, and power expenditure at both the UE 120 and the network node 110.

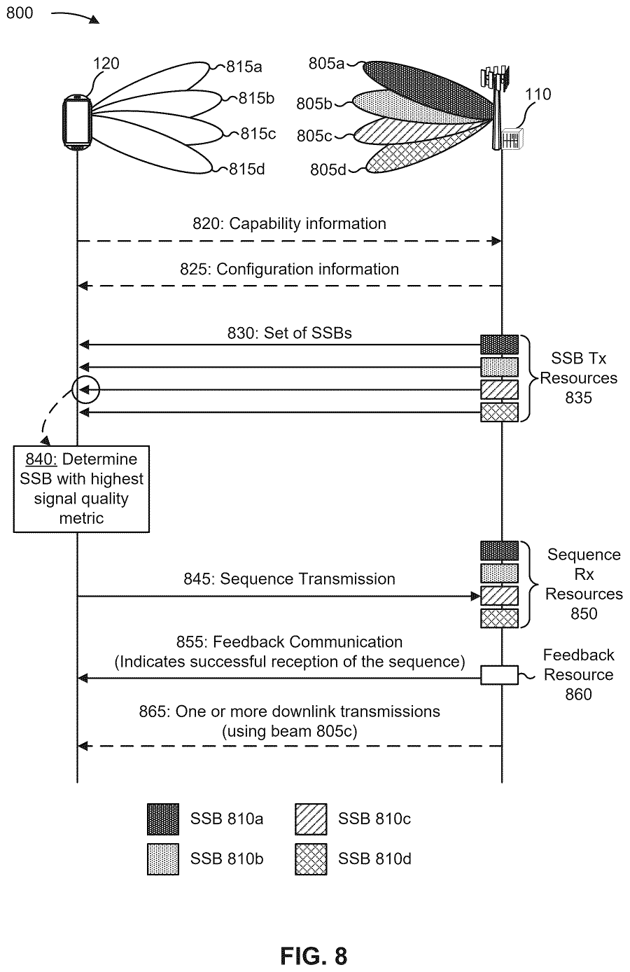

FIG. 8 is a diagram illustrating an example 800 associated with beam management in accordance with a low-power mode, in accordance with the present disclosure. Example 800 may implement or be implemented by one or more aspects of FIGS. 1 through 7. For instance, example 800 includes wireless communications between the network node 110 and the UE 120. Additionally, beams 805a, 805b, 805c, and 805d may respectively be examples of beams 705a, 705b, 705c, and 705d, or any other network node 110 beams described elsewhere herein. Additionally, SSBs 810a, 810b, 810c, and 810d may respectively be examples of SSBs 710a, 710b, 710c, and 710d. Further, while example 800 describes the use of the set of SSBs 810 for one or more beam management techniques, in some examples, a set of LP-SSs (as described elsewhere herein) may be used alternatively to or in addition to the set of SSBs 810. Additionally, as shown if FIG. 8, the UE 120 may be associated with beams 815a, 815b, 815c, and 815d. In some examples, the set of beams 815 may be transmit/receive beams for use at the UE 120 to facilitate wireless communications. As described elsewhere herein, the beams 805 and the beams 815 may be combined to form beam pairs for communication between the network node 110 and the UE 120. For instance, beam 805a and beam 815a may make a first beam pair, beam 805b and beam 815b may make a second beam pair, beam 805c and beam 815c may make a third beam pair, and beam 805d and beam 815d may make a fourth beam pair.

Alternative examples of the following may be implemented, where some operations are performed in a different order than described, or not described at all. In some cases, one or more operations may include additional features not mentioned below, or further operations may be added. In addition, while example 800 shows operations between the UE 120 and the network node 110, the communications may occur between any number of network devices of various types described herein.

In some aspects, as shown by first operation 820, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the UE 120. The one or more parameters may be indicated via respective information elements (IEs) included in a capability report.

The capability information may indicate whether the UE 120 supports a feature and/or one or more parameters related to the feature. For example, the capability information may indicate a capability and/or parameter for supporting beam management during a low-power mode of the UE 120. In other words, the UE 120 may indicate support for performing beam selection across the set of beams 805 using an LP-WUR (e.g., LP-WUR 510/720) while a main radio of the UE 120 is turned off or operated in a deep sleep (e.g., the main radio 505/715). In some examples, the capability information may indicate a capability and/or parameter for supporting transmission of simple waveforms to indicate information associated with beam quality. In other words, the UE 120 may indicate that the UE 120 includes an LP-transmitter (e.g., LP-transmitter 535/725) that the UE 120 may use to transmit simple waveforms while the main radio is turned off or operated in a deep sleep. One or more operations described herein may be based on the capability information. For example, the UE 120 may perform one or more operations of example 800 in accordance with the capability information or may receive configuration information that is in accordance with the capability information.

The network node 110 may determine configuration information for the UE 120 based on the capability information. For example, the network node 110 may determine that the UE 120 is to be configured with a sequence (described elsewhere herein) for use in beam 805 selection associated with the set of SSBs 810 based on the capability information indicating that the UE 120 supports the transmission of simple waveforms to indicate information associated with beam quality. In some examples, the configuration information may indicate a set of SSB transmission resources 835 and/or a set of sequence reception resources 850 (described elsewhere herein) based on the capability information indicating that the UE 120 supports beam management during a low-power mode of the UE 120.

In a second operation 825, the network node 110 may optionally transmit, and the UE 120 may receive, the configuration information. In some aspects, the UE 120 may receive the configuration information via one or more of system information signaling (e.g., a master information block (MIB) and/or a SIB, among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information indicates the sequence to the UE 120. For example, the sequence may be information that the UE 120 may include in a transmission using the LP-transmitter when the UE 120 is monitoring for LP-WUSs. In some examples, the sequence may be associated with identifying the UE 120. In other words, the sequence is UE-specific such that the network node 110 may identify that a wireless signal is from the UE 120 based on the wireless signal including the sequence specific to the UE 120. In some examples, the sequence may be an example of the overlaid sequence 625, with reference to FIG. 6. For instance, the sequence may be an example of a Gold sequence, an M sequence, a computer searched sequence, or a Zadoff Chu sequence. Additionally, the information included in the sequence may be such that a number of RBs associated with transmission of the sequence may be less than an RB number threshold and the number of symbols associated with transmission of the sequence may be below a symbol number threshold. In some examples, the term “sequence” may be used interchangeably with the term “preamble” or “signal.”

In some examples, the configuration information may indicate the sequence reception resources 850. For example, the sequence reception resources 850 may be periodic time and frequency resources in which the network node 110 may monitor for and/or receive the sequence from the UE 120. In some examples, the set of sequence reception resources 850 may be respectively mapped to the set of SSBs 810. For instance, as shown in FIG. 6, a first sequence reception resource 850 may be mapped to SSB 810a, a second sequence reception resource 850 may be mapped to SSB 810b, a third sequence reception resource 850 may be mapped to SSB 810c, and a fourth sequence reception resource 850 may be mapped to SSB 810d.

In some examples, the sequence reception resources 850 may be similar to and/or leverage aspects of PRACH occasions. For example, PRACH occasions may be a set of time and frequency resources allocated within a cell for the UE 120 to transmit random access preambles, and may be associated with the SSBs 810. In some examples, each SSB 810 transmitted by the network node 110 may be associated with a set of PRACH occasions, enabling the UE 120 to initiate access based on the detected SSB 810. Such association between the SSBs 810 and PRACH occasions may enable a random access preamble transmission from the UE 120 to align with the corresponding beam 805 of the SSB 810, facilitating efficient communication and synchronization. The network node 110 may indicate the mapping between PRACH occasions and the SSBs 810 to the UE 120 through the configuration information, allowing the UE 120 to identify PRACH resources based on the SSB 810 that the UE 120 selects. Therefore, the sequence reception resources 850 may be a set of PRACH occasions signaled by the network node 110 or a separate set of resources that leverage one or more aspects of PRACH occasions described herein.

In some examples, the sequence reception resources 850 may identify the UE 120 in addition to, or alternatively to, the sequence. For example, the sequence reception resources 850 may be specific to the UE 120, such that the network node 110 may identify that a wireless signal is from the UE 120 based on receiving the wireless signal during one or more of the sequence reception resources 850.

In a third operation 830, the network node 110 may transmit, and the UE 120 may receive, a set of SSB transmissions corresponding to the set of SSBs 810. For instance, as illustrated in FIG. 6, the network node 110 may transmit the set of SSBs via a respective set of SSB transmission resources 835. For example, the network node 110 may transmit the SSB 810a using a first SSB transmission resource 835, transmit the SSB 810b using a second SSB transmission resource 835, transmit the SSB 810c using a third SSB transmission resource 835, and transmit the SSB 810d using a fourth SSB transmission resource 835.

In some examples, the UE 120 may receive the set of SSBs 810 while monitoring for an LP-WUS/LP-SS. For example, the UE 120 may receive the set of SSBs 810 via the LP-WUR based on operating in a low-power mode where the main radio is turned off or operated in a deep sleep. In some examples, the UE 120 may refrain from decoding and/or processing the set of SSBs 810 using the LP-WUR, to reduce energy expenditure at the UE 120. Rather, in a fourth operation 840, the UE 120 may measure a signal quality metric for each of the received SSBs 810 to determine which of the beams 805 at the network node 110 may be the best beam for communicating with the UE 120. For instance, in example 800, the UE 120 may determine that the SSB 810c is associated with a highest signal quality metric of the set of SSBs 810. As described herein, the signal quality metric measured by the UE 120 as part of the fourth operation 840 may be one or more of RSRP, RSRQ, SINR, SNR, RSSI, CQI, BER, BLER, EVM, or SE.

In a fifth operation 845, the UE 120 may transmit, and the network node 110 may receive, a sequence transmission via one of the sequence reception resources 850. For example, the sequence transmission may be a simple waveform such as OOK (or any other simple waveform described herein) that includes the sequence indicated to the UE 120. In some examples, the UE 120 may transmit the sequence transmission via the LP-transmitter. In other words, the UE 120 may transmit the sequence transmission while the main radio is turned off or operated in a deep sleep, which may reduce power expenditure at the UE 120.

In some examples, the UE 120 may transmit the sequence transmission via a sequence reception resource 850 associated with the SSB 810 that the UE 120 measures as having the highest signal quality metric as part of the fourth operation 840. For instance, in example 800, the UE 120 may transmit the sequence transmission via the third sequence reception resource 850 that is mapped to SSB 810c based on the UE 120 measuring the SSB 810c as being associated with the highest signal quality metric of the set of SSBs 810.

In some examples, the UE 120 may periodically transmit sequence transmissions. For example, as described herein, the sequence reception resources 850 may be periodic, and the UE 120 may transmit a sequence transmission during each period of the sequence reception resources 850, where the UE 120 transmits a given instance of the sequence transmission using the sequence reception resource 850 that is associated with the SSB 810 that currently has the highest signal quality metric of the set of SSBs 810.

In some examples, the UE 120 may transmit the sequence transmission based on a trigger event, such as the SSB 810 that is associated with the highest signal quality metric changing. For instance, in example 800, prior to the fourth operation 840, the UE 120 may have measured SSB 810a as being associated with the highest signal quality metric. Therefore, during the fifth operation 845, the UE 120 may transmit the sequence transmission via the third sequence reception resource 850 to indicate to the network node 110 that the SSB 810 associated with the highest signal quality metric has been updated from SSB 810a to SSB 810c. If, during a given period of the sequence reception resources 850, the SSB 810 associated with the highest signal quality does not change, then the UE 120 may refrain from transmitting the sequence transmission, which may reduce power expenditure and signaling overhead at the UE 120 and/or the network node 110.

In some examples, the network node 110 may interpret reception of the sequence transmission via the third sequence reception resource 850 as an indication that the SSB 810c is associated with the highest signal quality metric. In other words, the network node 110 may process this sequence transmission as an indication that, to reach the UE 120, the network node 110 may use the beam 805c that was used to transmit the SSB 810c.

In a sixth operation 855, the network node 110 may transmit, and the UE 120 may receive, a feedback communication. For example, the feedback communication may indicate successful reception by the network node 110 of the sequence transmission and indicate that one or more subsequent downlink transmissions are associated with one or more spatial parameters associated with the SSB 810c. For example, the one or more spatial parameters may include one or more of a TCI state associated with beam 805c or a QCL parameter associated with beam 805c, among other examples.

In some examples, the feedback communication may be an OOK waveform (or any other simple waveform described elsewhere herein) such that the UE 120 may receive the feedback communication via the LP-WUR. Based on receiving the feedback communication via the LP-WUR, the UE may reduce power expenditure.

In some examples, the feedback communication may identify the UE 120. For example, the feedback communication may include a set of bits that identifies the UE 120. In some examples, the set of bits may indicate a radio network temporary identifier (RNTI), a cell radio network temporary identifier (C-RNTI), a temporary mobile subscriber identity (TMSI), a mobile equipment identifier (MEI), or an international mobile subscriber identity (IMSI). In some examples, the network node 110 may configure the UE 120 with an identifier via the configuration information or separate control signaling (e.g., separate system information signaling, RRC signaling, MAC signaling, and/or DCI, among other examples). In some examples, the feedback communication may include the sequence associated with the UE 120, where the sequence identifies the UE 120. In some examples, the feedback communication may be an LP-WUS and the identifier of the UE 120 may be a same UE identifier as used in all LP-WUS transmissions to the UE 120.

In some examples, the feedback communication may include another bit that indicates an ACK or NACK associated with the sequence reception. For example, a first value of the bit (e.g., ‘1’) may indicate an ACK, such that the first value indicates the successful reception of the sequence and that the one or more subsequent downlink transmissions are associated with the one or more spatial parameters associated with the SSB 810c (e.g., the subsequent downlink transmission may be transmitted via the beam 805c). Alternatively, a second value of the bit (e.g., ‘0’) may indicate a NACK, such that the second value indicates unsuccessful reception and/or decoding of the sequence and that the one or more subsequent downlink transmissions may be associated with the current spatial parameters used by the network node 110 to communicate with the UE 120 (e.g., the subsequent downlink transmission may be transmitted via the current beam 805 in use at the network node 110).

In some examples, the feedback communication may be transmitted via a feedback resource 860. For example, the feedback resource 860 may be a resource that is associated with the UE 120 receiving the feedback communication after the UE 120 transmits the sequence transmission. In some examples, the feedback resource 860 may identify the UE 120. For example, as part of the configuration information, the network node 110 may indicate the feedback resource 860. Therefore, based on receiving the feedback communication via the feedback resource 860, the UE 120 understands that the feedback communication is in accordance with the sequence transmission. In some examples, the feedback resource 860 may be periodic. In some examples, the feedback resource 860 may be from a set of resources that the UE 120 monitors for LP-WUSs. In such examples, the feedback communication may be an LP-WUS that the UE 120 may receive via the LP-WUR.

In some examples, the UE 120 may use a same beam 815 (e.g., same TCI state and/or same QCL parameter) to transmit the sequence and to receive the feedback communication. For example, if the UE 120 transmits the sequence transmission via the beam 815c, then the UE 120 may monitor and/or receive the feedback communication via the beam 815c. In some examples, after receiving the feedback communication that includes an ACK, the UE 120 may use the same beam 815 to monitor and/or receive the one or more subsequent downlink transmissions. That is, in example 800, the UE 120 may use the beam 815c to monitor and/or receive the subsequent downlink transmissions based on using the beam 815c for reception of the feedback communication.

In a seventh operation 865, the network node 110 may transmit, and the UE 120 may receive, one or more subsequent downlink transmissions. For example, the network node 110 may transmit the one or more subsequent downlink transmissions via the beam 805c and the UE 120 may receive via the beam 815c. In some examples, the one or more subsequent downlink transmissions may be LP-WUSs and/or LP-SSs that the UE 120 may receive via the LP-WUR. Additionally, or alternatively, the one or more subsequent downlink messages may be non-low-power transmissions, such as one or more of a PDSCH message, a PDCCH message, an SSB message (that the UE 120 is enabled to decode and/or process), a PBCH message, or a DMRS, among any other downlink signals described elsewhere herein. The UE 120 may receive the non-low-power transmissions via the main radio, after transitioning the main radio to an on state.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with beam management in accordance with a low-power mode.

As shown in FIG. 9, in some aspects, process 900 may include receiving, from a network node while monitoring for a WUS from the network node, a set of SSBs that are respectively mapped to a set of SSB transmission resources (block 910). For example, the UE (e.g., using reception component 1102 and/or communication manager 1106, depicted in FIG. 11) may receive, from a network node while monitoring for a WUS from the network node, a set of SSBs that are respectively mapped to a set of SSB transmission resources, as described above. In some aspects, the UE may receive the set of SSBs using the LP-WUR 520 and/or LP-WUR 720 described in connection with FIGS. 5 and 7 and/or may perform the receiving in a manner similar to that described above, e.g., at the third operation 830 of FIG. 8.

As further shown in FIG. 9, in some aspects, process 900 may include transmitting, to the network node, a sequence via a resource associated with the set of SSB transmission resources, wherein the resource is mapped to an SSB of the set of SSBs associated with a highest signal quality metric associated with the set of SSBs (block 920). For example, the UE (e.g., using transmission component 1104 and/or communication manager 1106, depicted in FIG. 11) may transmit, to the network node, a sequence via a resource associated with the set of SSB transmission resources, wherein the resource is mapped to an SSB of the set of SSBs associated with a highest signal quality metric associated with the set of SSBs, as described above. In some aspects, the UE may transmit the sequence using the LP-transmitter 535 and/or LP-transmitter 725 described in connection with FIGS. 5 and 7 and/or may perform the transmitting in a manner similar to that described above, e.g., at the fifth operation 845 in FIG. 8.

As further shown in FIG. 9, in some aspects, process 900 may include receiving, from the network node, a feedback communication that indicates successful reception of the sequence and an indication that one or more subsequent downlink transmissions are associated with a TCI state associated with the SSB (block 930). For example, the UE (e.g., using reception component 1102 and/or communication manager 1106, depicted in FIG. 11) may receive, from the network node, a feedback communication that indicates successful reception of the sequence and indicates that one or more subsequent downlink transmissions are associated with a TCI state associated with the SSB, as described above. In some aspects, the UE may receive the feedback communication using the LP-WUR 520 and/or LP-WUR 720 described in connection with FIGS. 5 and 7 and/or may perform the receiving in a manner similar to that described above, e.g., at 855 of FIG. 8.

Process 900 may include additional aspects, such as any single aspect or any combination of aspects described below and/or in connection with one or more other processes described elsewhere herein.

In a first aspect, process 900 includes receiving, from the network node, configuration information that indicates the sequence for use in beam selection associated with the set of SSBs, wherein transmission of the sequence via the resource mapped to the SSB is based at least in part on the configuration information indicating the sequence (e.g., as described in connection with FIG. 6 through FIG. 8).

In a second aspect, alone or in combination with the first aspect, the configuration information further indicates a set of sequence reception resources that are respectively mapped to the set of SSBs, and the resource for transmission of the sequence is from the set of sequence reception resources (e.g., as described in connection with FIG. 6 through FIG. 8).

In a third aspect, alone or in combination with one or more of the first and second aspects, the set of sequence reception resources are periodic in time (e.g., as described in connection with FIG. 6 through FIG. 8).

In a fourth aspect, alone or in combination with one or more of the first through third aspects, transmissions of the sequence that indicate the SSB associated with the highest quality metric are periodic (e.g., as described in connection with FIG. 6 through FIG. 8).

In a fifth aspect, alone or in combination with one or more of the first through fourth aspects, transmission of the sequence via the resource mapped to the SSB is based at least in part on a trigger event, and the trigger event is in accordance with the SSB being associated with the highest signal quality metric associated with the set of SSBs, e.g., as described in connection with FIG. 6 through FIG. 8.

In a sixth aspect, alone or in combination with one or more of the first through fifth aspects, transmission of the sequence, via the resource mapped to the SSB, indicates for the network node to use a beam at the network node associated with the TCI state for the one or more subsequent downlink transmissions, e.g., as described in connection with FIG. 6 through FIG. 8.

In a seventh aspect, alone or in combination with one or more of the first through sixth aspects, the feedback communication is an OOK waveform received via an LP-WUR (e.g., as described in connection with FIG. 6 through FIG. 8).

In an eighth aspect, alone or in combination with one or more of the first through seventh aspects, the feedback communication includes a set of bits that identifies the UE and an additional bit, wherein the additional bit indicates the successful reception of the sequence and indicates that the one or more subsequent downlink transmissions are associated with the TCI state (e.g., as described in connection with FIG. 6 through FIG. 8).

In a ninth aspect, alone or in combination with one or more of the first through eighth aspects, the feedback communication is received via a feedback resource that is associated with receiving an acknowledgement indication after transmission of the sequence, and the feedback resource identifies the UE, e.g., as described in connection with FIG. 6 through FIG. 8.

In a tenth aspect, alone or in combination with one or more of the first through ninth aspects, the feedback communication is received via a feedback resource that is from a set of resources associated with monitoring for LP-WUSs during one or more WUS occasions, and the feedback communication is an LP-WUS (e.g., as described in connection with FIG. 6 through FIG. 8).

In an eleventh aspect, alone or in combination with one or more of the first through tenth aspects, a same beam at the UE is used for transmission of the sequence and reception of the feedback communication (e.g., as described in connection with FIG. 6 through FIG. 8).

In a twelfth aspect, alone or in combination with one or more of the first through eleventh aspects, the set of SSBs are respectively associated with a set of beams at the network node, and the set of beams are respectively associated with a set of spatial directions of a cell of the network node (e.g., as described in connection with FIG. 6 through FIG. 8).

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with beam management in accordance with a low-power mode.

As shown in FIG. 10, in some aspects, process 1000 may include transmitting, to a UE, a set of SSBs that are respectively mapped to a set of SSB transmission resources (block 1010). For example, the network node (e.g., using transmission component 1204 and/or communication manager 1206, depicted in FIG. 12) may transmit, to a UE, a set of SSBs that are respectively mapped to a set of SSB transmission resources, as described above. In some aspects, the transmission of the set of SSBs may be performed in a manner similar to the transmission of the set of SSBs in the third operation 830 of FIG. 8.

As further shown in FIG. 10, in some aspects, process 1000 may include receiving, from the UE, a sequence via a resource associated with the set of SSB transmission resources, where the resource is mapped to an SSB of the set of SSBs associated with a highest signal quality metric associated with the set of SSBs (block 1020). For example, the network node (e.g., using reception component 1202 and/or communication manager 1206, depicted in FIG. 12) may receive, from the UE, a sequence via a resource associated with the set of SSB transmission resources, wherein the resource is mapped to an SSB of the set of SSBs associated with a highest signal quality metric associated with the set of SSBs, as described above. In some aspects, the reception of the sequence may be performed in a manner similar to the reception of the sequence transmission in the fifth operation 845 of FIG. 8.

As further shown in FIG. 10, in some aspects, process 1000 may include transmitting, to the UE, a feedback communication that indicates successful reception of the sequence and an indication that one or more subsequent downlink transmissions are associated with a TCI state associated with the SSB (block 1030). For example, the network node (e.g., using transmission component 1204 and/or communication manager 1206, depicted in FIG. 12) may transmit, to the UE, a feedback communication that indicates successful reception of the sequence and indicates that one or more subsequent downlink transmissions are associated with a TCI state associated with the SSB, as described above. In some aspects, the transmission of the feedback communication may be performed in a manner similar to the transmission of the feedback communication in the sixth operation 855 of FIG. 8.

Process 1000 may include additional aspects, such as any single aspect or any combination of aspects described below and/or in connection with one or more other processes described elsewhere herein.

In a first aspect, process 1000 includes transmitting, to the UE, configuration information that indicates the sequence for use by the UE in beam selection associated with the set of SSBs, wherein reception of the sequence via the resource mapped to the SSB is based at least in part on the configuration information indicating the sequence (e.g., as described in connection with FIG. 6 through FIG. 8).

In a second aspect, alone or in combination with the first aspect, the configuration information further indicates a set of sequence reception resources that are respectively mapped to the set of SSBs, and the resource for reception of the sequence is from the set of sequence reception resources (e.g., as described in connection with FIG. 6 through FIG. 8).

In a third aspect, alone or in combination with one or more of the first and second aspects, the set of sequence reception resources are periodic in time (e.g., as described in connection with FIG. 6 through FIG. 8).

In a fourth aspect, alone or in combination with one or more of the first through third aspects, transmissions of the sequence that indicate the SSB associated with the highest quality metric are periodic (e.g., as described in connection with FIG. 6 through FIG. 8).

In a fifth aspect, alone or in combination with one or more of the first through fourth aspects, reception of the sequence via the resource mapped to the SSB is based at least in part on a trigger event, and the trigger event is in accordance with the SSB being associated with the highest signal quality metric associated with the set of SSBs (e.g., as described in connection with FIG. 6 through FIG. 8).

In a sixth aspect, alone or in combination with one or more of the first through fifth aspects, reception of the sequence, via the resource mapped to the SSB, indicates for the network node to use a beam associated with the TCI state for the one or more subsequent downlink transmissions (e.g., as described in connection with FIG. 6 through FIG. 8).

In a seventh aspect, alone or in combination with one or more of the first through sixth aspects, the feedback communication is an OOK waveform transmitted via an LP-WUR (e.g., as described in connection with FIG. 6 through FIG. 8).

In an eighth aspect, alone or in combination with one or more of the first through seventh aspects, the feedback communication includes a set of bits that identifies the UE and an additional bit, wherein the additional bit indicates the successful reception of the sequence and indicates that the one or more subsequent downlink transmissions are associated with the TCI state (e.g., as described in connection with FIG. 6 through FIG. 8).

In a ninth aspect, alone or in combination with one or more of the first through eighth aspects, the feedback communication is transmitted via a feedback resource that is associated with transmitting an acknowledgement indication after transmission of the sequence, and the feedback resource identifies the UE (e.g., as described in connection with FIG. 6 through FIG. 8).

In a tenth aspect, alone or in combination with one or more of the first through ninth aspects, the feedback communication is transmitted via a feedback resource is from a set of resources associated with the UE monitoring for LP-WUSs during one or more WUS occasions, and the feedback communication is an LP-WUS (e.g., as described in connection with FIG. 6 through FIG. 8).

In an eleventh aspect, alone or in combination with one or more of the first through tenth aspects, the set of SSBs are respectively associated with a set of beams at the network node, and the set of beams are respectively associated with a set of spatial directions of a cell of the network node (e.g., as described in connection with FIG. 6 through FIG. 8).

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 3 through 8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a network node while monitoring for a WUS from the network node, a set of SSBs that are respectively mapped to a set of SSB transmission resources. The transmission component 1104 may transmit, to the network node, a sequence via a resource associated with the set of SSB transmission resources, wherein the resource is mapped to an SSB of the set of SSBs associated with a highest signal quality metric associated with the set of SSBs. The reception component 1102 may receive, from the network node, a feedback communication that indicates successful reception of the sequence and an indication that one or more subsequent downlink transmissions are associated with a TCI state associated with the SSB.

The reception component 1102 may receive, from the network node, configuration information that indicates the sequence for use in beam selection associated with the set of SSBs, wherein transmission of the sequence via the resource mapped to the SSB is based at least in part on the configuration information indicating the sequence.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 3 through 8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, a set of SSBs that are respectively mapped to a set of SSB transmission resources. The reception component 1202 may receive, from the UE, a sequence via a resource associated with the set of SSB transmission resources, wherein the resource is mapped to an SSB of the set of SSBs associated with a highest signal quality metric associated with the set of SSBs. The transmission component 1204 may transmit, to the UE, a feedback communication that indicates successful reception of the sequence and indicates that one or more subsequent downlink transmissions are associated with a TCI state associated with the SSB.

The transmission component 1204 may transmit, to the UE, configuration information that indicates the sequence for use by the UE in beam selection associated with the set of SSBs, wherein reception of the sequence via the resource mapped to the SSB is based at least in part on the configuration information indicating the sequence.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving, from a network node while monitoring for a wakeup signal (WUS) from the network node, a set of synchronization signal blocks (SSBs) that are respectively mapped to a set of SSB transmission resources; transmitting, to the network node, a sequence via a resource associated with the set of SSB transmission resources, wherein the resource is mapped to an SSB of the set of SSBs associated with a highest signal quality metric associated with the set of SSBs; and receiving, from the network node, a feedback communication that indicates successful reception of the sequence and indicates that one or more subsequent downlink transmissions are associated with a transmission configuration indication (TCI) state associated with the SSB.

Aspect 2: The method of Aspect 1, further comprising: receiving, from the network node, configuration information that indicates the sequence for use in beam selection associated with the set of SSBs, wherein transmission of the sequence via the resource mapped to the SSB is based at least in part on the configuration information indicating the sequence.

Aspect 3: The method of Aspect 2, wherein the configuration information further indicates a set of sequence reception resources that are respectively mapped to the set of SSBs, and wherein the resource for transmission of the sequence is from the set of sequence reception resources.

Aspect 4: The method of Aspect 3, wherein the set of sequence reception resources are periodic in time.

Aspect 5: The method of any of Aspects 1-4, wherein transmissions of the sequence that indicate the SSB associated with the highest quality metric are periodic.

Aspect 6: The method of any of Aspects 1-5, wherein transmission of the sequence via the resource mapped to the SSB is based at least in part on a trigger event, and wherein the trigger event is in accordance with the SSB being associated with the highest signal quality metric associated with the set of SSBs.

Aspect 7: The method of any of Aspects 1-6, wherein transmission of the sequence, via the resource mapped to the SSB, indicates for the network node to use a beam at the network node associated with the TCI state for the one or more subsequent downlink transmissions.

Aspect 8: The method of any of Aspects 1-7, wherein the feedback communication is an on-off keying (OOK) waveform received via a low-power wakeup radio (LP-WUR).

Aspect 9: The method of any of Aspects 1-8, wherein the feedback communication includes a set of bits that identifies the UE and an additional bit, wherein the additional bit indicates the successful reception of the sequence and indicates that the one or more subsequent downlink transmissions are associated with the TCI state.

Aspect 10: The method of any of Aspects 1-9, wherein the feedback communication is received via a feedback resource that is associated with receiving an acknowledgement indication after transmission of the sequence, and wherein the feedback resource identifies the UE.

Aspect 11: The method of any of Aspects 1-10, wherein the feedback communication is received via a feedback resource that is from a set of resources associated with monitoring for low-power WUSs (LP-WUSs) during one or more WUS occasions, and wherein the feedback communication is an LP-WUS.

Aspect 12: The method of any of Aspects 1-11, wherein a same beam at the UE is used for transmission of the sequence and reception of the feedback communication.

Aspect 13: The method of any of Aspects 1-12, wherein the set of SSBs are respectively associated with a set of beams at the network node, and wherein the set of beams are respectively associated with a set of spatial directions of a cell of the network node.

Aspect 14: A method of wireless communication performed by a network node, comprising: transmitting, to a user equipment (UE), a set of synchronization signal blocks (SSBs) that are respectively mapped to a set of SSB transmission resources; receiving, from the UE, a sequence via a resource associated with the set of SSB transmission resources, wherein the resource is mapped to an SSB of the set of SSBs associated with a highest signal quality metric associated with the set of SSBs; and transmitting, to the UE, a feedback communication that indicates successful reception of the sequence and indicates that one or more subsequent downlink transmissions are associated with a transmission configuration indication (TCI) state associated with the SSB.

Aspect 15: The method of Aspect 14, further comprising: transmitting, to the UE, configuration information that indicates the sequence for use by the UE in beam selection associated with the set of SSBs, wherein reception of the sequence via the resource mapped to the SSB is based at least in part on the configuration information indicating the sequence.

Aspect 16: The method of Aspect 15, wherein the configuration information further indicates a set of sequence reception resources that are respectively mapped to the set of SSBs, and wherein the resource for reception of the sequence is from the set of sequence reception resources.

Aspect 17: The method of Aspect 16, wherein the set of sequence reception resources are periodic in time.

Aspect 18: The method of any of Aspects 14-17, wherein transmissions of the sequence that indicate the SSB associated with the highest quality metric are periodic.

Aspect 19: The method of any of Aspects 14-18, wherein reception of the sequence via the resource mapped to the SSB is based at least in part on a trigger event, and wherein the trigger event is in accordance with the SSB being associated with the highest signal quality metric associated with the set of SSBs.

Aspect 20: The method of any of Aspects 14-19, wherein reception of the sequence, via the resource mapped to the SSB, indicates for the network node to use a beam associated with the TCI state for the one or more subsequent downlink transmissions.

Aspect 21: The method of any of Aspects 14-20, wherein the feedback communication is an on-off keying (OOK) waveform transmitted via a low-power wakeup radio (LP-WUR).

Aspect 22: The method of any of Aspects 14-21, wherein the feedback communication includes a set of bits that identifies the UE and an additional bit, wherein the additional bit indicates the successful reception of the sequence and indicates that the one or more subsequent downlink transmissions are associated with the TCI state.

Aspect 23: The method of any of Aspects 14-22, wherein the feedback communication is transmitted via a feedback resource that is associated with transmitting an acknowledgement indication after transmission of the sequence, and wherein the feedback resource identifies the UE.

Aspect 24: The method of any of Aspects 14-23, wherein the feedback communication is transmitted via a feedback resource is from a set of resources associated with the UE monitoring for low-power wakeup signals (LP-WUSs) during one or more wakeup signal (WUS) occasions, and wherein the feedback communication is an LP-WUS.

Aspect 25: The method of any of Aspects 14-24, wherein the set of SSBs are respectively associated with a set of beams at the network node, and wherein the set of beams are respectively associated with a set of spatial directions of a cell of the network node.

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

Aspect 27: An apparatus for wireless communication at a device, the apparatus comprising one or more memories and one or more processors coupled to the one or more memories, the one or more processors configured to cause the device to perform the method of one or more of Aspects 1-25.

Aspect 28: An apparatus for wireless communication, the apparatus comprising at least one means for performing the method of one or more of Aspects 1-25.

Aspect 29: A non-transitory computer-readable medium storing code for wireless communication, the code comprising instructions executable by one or more processors to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

Aspect 31: A device for wireless communication, the device comprising a processing system that includes one or more processors and one or more memories coupled with the one or more processors, the processing system configured to cause the device to perform the method of one or more of Aspects 1-25.

Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, the one or more processors individually or collectively configured to:
receive, from a network node while monitoring for a wakeup signal (WUS) from the network node, a set of synchronization signal blocks (SSBs) that are respectively mapped to a set of SSB transmission resources;
transmit, to the network node, a sequence via a resource associated with the set of SSB transmission resources, wherein the resource is mapped to an SSB of the set of SSBs associated with a highest signal quality metric associated with the set of SSBs; and
receive, from the network node, a feedback communication that indicates successful reception of the sequence and indicates that one or more subsequent downlink transmissions are associated with a transmission configuration indication (TCI) state associated with the SSB.

2. The UE of claim 1, wherein the one or more processors, individually or collectively, are further configured to:
receive, from the network node, configuration information that indicates the sequence for use in beam selection associated with the set of SSBs, wherein transmission of the sequence via the resource mapped to the SSB is based at least in part on the configuration information indicating the sequence.

3. The UE of claim 2, wherein the configuration information further indicates a set of sequence reception resources that are respectively mapped to the set of SSBs, and wherein the resource for transmission of the sequence is from the set of sequence reception resources.

4. The UE of claim 3, wherein the set of sequence reception resources are periodic in time.

5. The UE of claim 1, wherein transmissions of the sequence that indicate the SSB associated with the highest quality metric are periodic.

6. The UE of claim 1, wherein transmission of the sequence via the resource mapped to the SSB is based at least in part on a trigger event, and wherein the trigger event is in accordance with the SSB being associated with the highest signal quality metric associated with the set of SSBs.

7. The UE of claim 1, wherein transmission of the sequence, via the resource mapped to the SSB, indicates for the network node to use a beam at the network node associated with the TCI state for the one or more subsequent downlink transmissions.

8. The UE of claim 1, wherein the feedback communication is an on-off keying (OOK) waveform received via a low-power wakeup radio (LP-WUR).

9. The UE of claim 1, wherein the feedback communication includes a set of bits that identifies the UE and an additional bit, wherein the additional bit indicates the successful reception of the sequence and indicates that the one or more subsequent downlink transmissions are associated with the TCI state.

10. The UE of claim 1, wherein the feedback communication is received via a feedback resource that is associated with receiving an acknowledgement indication after transmission of the sequence, and wherein the feedback resource identifies the UE.

11. The UE of claim 1, wherein the feedback communication is received via a feedback resource that is from a set of resources associated with monitoring for low-power WUSs (LP-WUSs) during one or more WUS occasions, and wherein the feedback communication is an LP-WUS.

12. The UE of claim 1, wherein a same beam at the UE is used for transmission of the sequence and reception of the feedback communication.

13. The UE of claim 1, wherein the set of SSBs are respectively associated with a set of beams at the network node, and wherein the set of beams are respectively associated with a set of spatial directions of a cell of the network node.

14. A network node for wireless communication, comprising:
one or more memories; and
one or more processors, coupled to the one or more memories, the one or more processors individually or collectively configured to:
transmit, to a user equipment (UE), a set of synchronization signal blocks (SSBs) that are respectively mapped to a set of SSB transmission resources;
receive, from the UE, a sequence via a resource associated with the set of SSB transmission resources, wherein the resource is mapped to an SSB of the set of SSBs associated with a highest signal quality metric associated with the set of SSBs; and
transmit, to the UE, a feedback communication that indicates successful reception of the sequence and indicates that one or more subsequent downlink transmissions are associated with a transmission configuration indication (TCI) state associated with the SSB.

15. The network node of claim 14, wherein the one or more processors, individually or collectively, are further configured to:
transmit, to the UE, configuration information that indicates the sequence for use by the UE in beam selection associated with the set of SSBs, wherein reception of the sequence via the resource mapped to the SSB is based at least in part on the configuration information indicating the sequence.

16. The network node of claim 15, wherein the configuration information further indicates a set of sequence reception resources that are respectively mapped to the set of SSBs, and wherein the resource for reception of the sequence is from the set of sequence reception resources.

17. The network node of claim 16, wherein the set of sequence reception resources are periodic in time.

18. The network node of claim 14, wherein transmissions of the sequence that indicate the SSB associated with the highest quality metric are periodic.

19. The network node of claim 14, wherein reception of the sequence via the resource mapped to the SSB is based at least in part on a trigger event, and wherein the trigger event is in accordance with the SSB being associated with the highest signal quality metric associated with the set of SSBs.

20. The network node of claim 14, wherein reception of the sequence, via the resource mapped to the SSB, indicates for the network node to use a beam associated with the TCI state for the one or more subsequent downlink transmissions.

21. The network node of claim 14, wherein the feedback communication is an on-off keying (OOK) waveform transmitted via a low-power wakeup radio (LP-WUR).

22. The network node of claim 14, wherein the feedback communication includes a set of bits that identifies the UE and an additional bit, wherein the additional bit indicates the successful reception of the sequence and indicates that the one or more subsequent downlink transmissions are associated with the TCI state.

23. The network node of claim 14, wherein the feedback communication is transmitted via a feedback resource that is associated with transmitting an acknowledgement indication after transmission of the sequence, and wherein the feedback resource identifies the UE.

24. The network node of claim 14, wherein the feedback communication is transmitted via a feedback resource is from a set of resources associated with the UE monitoring for low-power wakeup signals (LP-WUSs) during one or more wakeup signal (WUS) occasions, and wherein the feedback communication is an LP-WUS.

25. The network node of claim 14, wherein the set of SSBs are respectively associated with a set of beams at the network node, and wherein the set of beams are respectively associated with a set of spatial directions of a cell of the network node.

26. A method of wireless communication performed by a user equipment (UE), comprising:
receiving, from a network node while monitoring for a wakeup signal (WUS) from the network node, a set of synchronization signal blocks (SSBs) that are respectively mapped to a set of SSB transmission resources;
transmitting, to the network node, a sequence via a resource associated with the set of SSB transmission resources, wherein the resource is mapped to an SSB of the set of SSBs associated with a highest signal quality metric associated with the set of SSBs; and
receiving, from the network node, a feedback communication that indicates successful reception of the sequence and indicates that one or more subsequent downlink transmissions are associated with a transmission configuration indication (TCI) state associated with the SSB.

27. The method of claim 26, further comprising:
receiving, from the network node, configuration information that indicates the sequence for use in beam selection associated with the set of SSBs, wherein transmission of the sequence via the resource mapped to the SSB is based at least in part on the configuration information indicating the sequence.

28. The method of claim 27, wherein the configuration information further indicates a set of sequence reception resources that are respectively mapped to the set of SSBs, and wherein the resource for transmission of the sequence is from the set of sequence reception resources.

29. The method of claim 28, wherein the set of sequence reception resources are periodic in time.

30. A method of wireless communication performed by a network node, comprising:
transmitting, to a user equipment (UE), a set of synchronization signal blocks (SSBs) that are respectively mapped to a set of SSB transmission resources;
receiving, from the UE, a sequence via a resource associated with the set of SSB transmission resources, wherein the resource is mapped to an SSB of the set of SSBs associated with a highest signal quality metric associated with the set of SSBs; and
transmitting, to the UE, a feedback communication that indicates successful reception of the sequence and indicates that one or more subsequent downlink transmissions are associated with a transmission configuration indication (TCI) state associated with the SSB.
